(19) United States
(12) Patent Application Publication
(10) Pub. No.: US 2009/0059615 A1
(43) Pub. Date: Mar. 5, 2009

(54) Fiber optically enhanced reflective strip

(76) Inventor: Lee Wainright, Bechlehem, PA (US)

Correspondence Address: Feldman Law Group, P.C., 12 E. 41St Street, New York, NY, 10017, US

(21) Appl. No.: 12/229,197

(22) Filed: Aug. 20, 2008

Related U.S. Application Data
(60) Provisional application No. 60/966,849, filed on Aug. 31, 2007.

(51) Int. Cl. F21V 7/04

(52) U.S. Cl. 362/555

(57) ABSTRACT

A fiber optically enhanced reflective strip having a first material, a light pipe inside the first material having an end, and a LED positioned proximate the end of the light pipe to transmit visible or infrared light to the first material to illuminate the material is described. The LED transmits single or multiple colored light energies in separated or combined forms through the light pipes. The strip produces multiple spectrums of visible and/or infrared light output that can be recognized by special IR sensitive equipment. The strip includes an external removable battery source and current limiting resistor that run on quiescent technology allowing the strip to output light for at least two to three weeks on lightweight and tiny batteries that are operated via a manual or automatic switch. The strip includes attachment means that can be attached to the safety apparels. The strip is used for quick identification and allocation of an individual in low or no visibility environments.

### RELATED APPLICATIONS

This application claims the priority of U.S. Provisional Application No. U.S. Ser. No. 60/966,849, filed Aug. 24, 2007.

### BACKGROUND OF THE INVENTION

1. Field of the invention

The present invention relates to high visibility clothing apparel components, and more particularly, to a fiber optically enhanced safety reflective strip adapted to be used for quick identification and allocation of an individual in low visibility environments.

2. Description of related art

Many systems and methods have been suggested in the prior arts for increasing the visibility of apparels being used in low lighted working environments. However, these prior arts are not suited to be used in environments where light is totally absent. For example, these prior systems and methods cannot be employed to assist those people searching for people during emergency or rescue operations in the areas, for example, mines without power, construction sites without power, and emergency civilian circumstances under power failure. Therefore, a system, method, and apparatus is needed that not only increases the visibility of people working in low lighted working environments, but also designates the position of other objects using light output in absent lighted working conditions. In addition, there is an absence of prior art to describe the ability for apparel based light output methods to continue emitting light continuously for extended periods of time for emergency situations lacking power beyond a few hours into several weeks from small, lightweight, low-current capacity batteries.

U.S. Pat. No. 5,249,106 (Barnes) discloses safety apparels including electric lights to provide increased visibility. However, these lights require great amounts of current, thus requiring large battery packs to drive the displays. Electroluminescence (EL) as described in U.S. Pat. No. 7,229,183 (Golle) also requires a large amount of current draw and heavy battery packs, and outputs very low light. The users such as hikers and campers may appreciate the apparel that can be worn with very little additional weight of batteries.

The use of Light Emitting Diodes (LED) or similar lights attached to the surfaces of fabric in conjunction with safety vests can be seen in U.S. Pat. No. 4,709,307, (Branom), U.S. Pat. No. 6,517,214 (Mitchell Jr), and U.S. Pat. No. 6,834,395 (Fuentes), where illuminated strips use embedded LEDs. The embedded LEDs connected with wires also can be seen in U.S. Pat. No. 4,761,720 (Solow). Some fiber optic options and methods are described in U.S. Pat. No. 4,875,144; U.S. Pat. No. 6,217,188; and U.S. Pat. No. 6,651,365. However, most of these prior arts require large PCBs to control the displays and require rather high current draws to drive the electronic portions. All of these prior arts use heavy battery packs containing several “AA” styles of batteries that quickly get drained and prevent the output of light beyond a few hours to a day or two. LEDs and electric lights incorporated in these prior arts draw tremendous amounts of current and thus requiring many more batteries to keep them lighted for long periods of time. A battery pack is needed that is able to continue outputting light energy for periods of time beyond a few hours extending into days and weeks without the necessity of changing batteries.

Many of the prior art reflective strips use phosphorescent materials embedded in fabrics with the addition of high output glass beaded reflecting strips, but these materials require light to shine on them rather than emitting light from them. Hence, these prior arts have proven inadequate for locating people in low or no visibility environments due to their inability to reflect light unless they receive light.

The prior art also does not disclose or suggest the use of reflective strips to notify co-workers and others on a noisy construction site about a problem which is present of a potentially dangerous situation.

The use of Infrared (IR) frequencies to penetrate opaque environments such as dust, debris, smoke, condensation fog, and fabric can be seen in the prior arts (U.S. Pat. No. 5,225,828, Walleston, U.S. Pat. No. 6,466,710, Pergande and U.S. Pat. No. 6,698,330, Witte) to overcome the limitations of LED lighted products to be used in the above mentioned opaque environments. However, all of these arts rely upon a transmitter, receiver, or transponder mounted somewhere on the item or individual in the line of sight of the corresponding receiver/transmitter of an observer. These prior art references substantially fail to work if the transponder is located out of sight of the corresponding receiver because it is the nature of IR to be in the “line-of-sight” to function as a data transmission method. Therefore, an IR transmission system for the apparel is needed that facilitates 360 degrees light output without the need of being transmitted, received, or transponder in the line of sight of the corresponding receiver/transmitter of the observer.

Also, none of the references address the need of a safety apparel that can be conveniently used in the environments where there is no light available to reflect from the person wearing such apparel. Therefore, there is also a need of a reflective means for the safety apparels that can address all the above concerns by not only meeting the American National Standards Institute (ANSI) standard regarding the application of reflective strip, but also provides a continuous 360 degrees light output from the apparel.

### SUMMARY OF THE INVENTION

A fiber optically enhanced reflective strip having a first material, a light pipe inside the first material having an end, and a LED positioned proximate the end of the light pipe to transmit visible or infrared light to the first material to illuminate the material is described. The first material is embedded with one or more glass beads adapted to facilitate high reflectivity. The ball or bubble like shape of the light pipe allows the light to diffuse laterally in addition to perpendicular to the axis to light up the glass beads that produces high frequency light output from the strip. The reflective strip contains high reflectivity material similar to 3M High Visibility Reflective 6260 material. The reflective strip has an under surface that includes an attachment means that enable the strip to be attached to the fabric or other surfaces. The attachment means can be made of a magnetic means for being attached to the metallic surfaces. The attachment means also can be made of Hook and Loop material such as the type under the trade name of “Velcro” for being fastened to fabric and other surfaces.

The reflective strip includes one or more light pipes made of flexible transparent strands of plastic that are preferably adapted to carry visible and/or infra red light energy. The light pipes have their proximal ends defining the optic fiber end points. The light pipes have an ability to allow more than one light source to enter the light pipes to facilitate the user to have a choice to use separate or combined visible or infrared light energy output. The light pipes maximize the infrared footprint by spreading the infrared transmission across a larger surface. In one embodiment, the light pipes have their distal ends bundled together to define a tip that is connected to at least one light emitting diode. The light emitting diode is mounted within an optically clear epoxy filled tube that protects the diode from external moisture and also acts as an air insulator to prevent shorting of the diode. The light emitting diode separately or simultaneously emits a visible and/or an infra red light energy. The light emitting diode can produce over 300 points of light output.

The reflective strip has a covering layer that is adapted to protect the light pipe from being contacted with any exterior surfaces. The covering layer has a bottom surface adapted to be connected to the first material of the strip. The covering layer has a clear and highly reflective top surface adapted to be aligned or exposed to a fabric surface.

The reflective strip includes an external battery source adapted to supply power to the light emitting diode. The battery source is adapted to be connected to a current limiting resistor that lowers the current draw of the light emitting diode. The battery source and the current limiting resistor are adapted to be connected to each other through a switch that can be operated manually or automatically to light the light emitting diode in any desired flashing or steady on state. The battery source incorporates quiescent technique to facilitate batteries within the battery source to produce continuous output for at least two to three weeks.

The reflective strip has an ability to produce different colored visible and/or infrared light output at the same time using multiple light emitting diodes or RGB diodes containing all three colors. The small area of the first material of the strip can be utilized to accommodate or occupy multiple overlapping images or alphanumeric characters that can be individually or simultaneously operable via user-selectable switches. The strip defines a flash light embodiment wherein the fiber optic points of the reflective strip are condensed into a small circular area, but other graphic designs are also contemplated, that emits an intense focus of visible or infrared light energy that acts as a flashlight in darkened areas. The fiber optics end points of the reflective strip can be implanted on the front and rear areas of the safety apparel with different colored light emitting diodes to designate front and back body portions of the wearer of the safety apparel. The infrared light energy emitted by the light emitting diodes is recognizable by special infrared sensitive equipment (FLIR Forward Looking Infrared) under adversely hostile visual conditions. The reflective strip can produce flashing patterns that can be used to alert rescuers, safety inspectors, and other personnel in the conditions such as increased amounts of dangerous gases and lack of oxygen. The reflective strip can, with proper additional electronic detection equipment, recognize physical stress levels of the wearer of the strip by identifying Bluetooth transmissions from remote sensors using biosensors. The reflective strip has a dual transmission embodiment that allows the user to selectively activate light emitting diodes to allow the user to produce a user-selectable high intensity light output that can be used as an emergency light in case of the battery failure. The reflective strip can also be well used in suspenders and utility belts. The reflective strip can be activated remotely through RF, UHF signals, or locally by way of motion detection switches for a preprogrammed timed period in order to ensure least power consumption and prolong battery life and actively notify wearers of approaching vehicles in mining environments by flashing simultaneously with other strips worn in the immediate vicinity.

### BRIEF DESCRIPTION OF DRAWINGS

The above mentioned and other features, aspects and advantages of the present invention will become better understood with regard to following description, appended claims and accompanying drawings, wherein like reference numerals refer to similar parts throughout the several views where:

FIG. 1 is a top and side perspective view of a fiber optically enhanced reflective strip constructed in accordance with the present invention;

FIG. 2 is a top view of one preferred embodiment of a plurality of fiber optic end points of the reflective strip of FIG. 1;

FIG. 3 is a top view of an alternative embodiment of the plurality of the fiber optic end points of the reflective strip of FIG. 1;

FIG. 4 is a top view of an alternative embodiment of the plurality of the fiber optic end points of the reflective strip of FIG. 1;

FIG. 5 is an enlarged cross-sectional side view taken along lines 5-5 of a portion of the reflective strip of FIG. 1;

FIG. 6 is a top and side perspective view of an alternative embodiment of fiber optically enhanced reflective strip of FIG. 1;

FIG. 7 is an enlarged cross-sectional side view taken along lines 7-7 of a portion of the reflective strip of FIG. 6;

FIG. 8 is a top view of an alternative embodiment of the fiber optically enhanced reflective strip of FIG. 1 illustrating that multiple fiber optic end displays occupying the same area of the strip;

FIG. 9 is an enlarged cross sectional side view taken along lines 9-9 of a portion of the reflective strip of FIG. 8;

FIG. 10 is a top view of an alternative flashlight embodiment of the fiber optically enhanced reflective strip of FIG. 1;

FIG. 11 is a cross sectional side view taken along lines 11-11 of a portion of the reflective strip of FIG. 10; and

FIG. 12 is a front perspective view of an alternative dual transmission embodiment of the fiber optically enhanced reflective strip of FIG. 1.

### DETAILED DESCRIPTION OF THE INVENTION

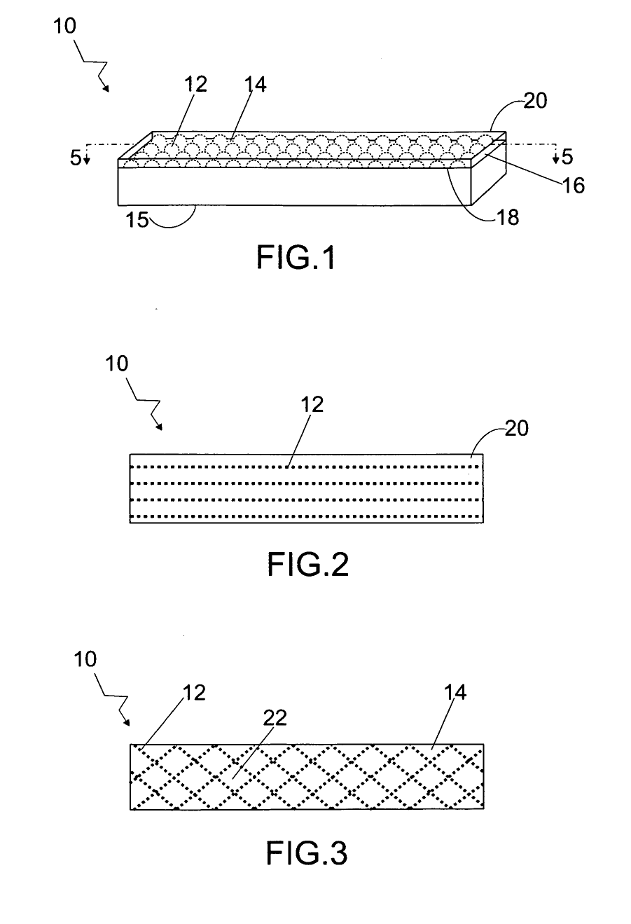

Referring initially to FIGS. 1 and 2, one preferred embodiment of a fiber optically enhanced reflective strip 10 is shown. Strip 10, in this one embodiment, is preferably made of vinyl based material and has a rectangular structure adapted to implant a plurality of plastic optic fiber endpoints 12, however, it is understood that the structure of strip 10 and quantity of endpoints 12 may vary in other alternative embodiments. Strip 10, in this one preferred embodiment, accommodates optic fiber end points 12 that define a line image throughout a first material 14 defined by top of the strip 10. The planer surface 14, in this one embodiment, includes one or more glass beads that facilitate high reflectivity to strip 10. The strip 10 has an undersurface 15 that preferably includes an attachment means such as Velcro strip, Glue strip, and/or Magnetic means that enable strip 10 to be attached to fabric or other surfaces. Each optic fiber end point 12 is strategically placed throughout the first material 14 and has a shape of ball like bubble adapted to spread or produce 360° of light output. The ball or bubble like shape of end points 12 allow the light to diffuse laterally for lighting up the glass beads in order to produce light output from the strip 10.

Strip 10 is attached with a covering layer 16 adapted to protect optic fiber end points 12 from being contacted with any exterior surfaces. The covering layer 16 is preferably made of highly reflective material such as 3M 6260 material, however, layer 16 also can be made of other clear fixative materials such as vinyl, epoxy, ultraviolet fixative glue and plastic in other alternative embodiments. The covering layer 16 has a bottom surface 18 that is attached to the first material 14 of strip 10 using fixatives or also can be sewn in to the strip surface 14. The covering layer 16 has top surface 20 that is preferably aligned and exposed to the surface of the fabric so as to provide an extra protective layer for the optic fiber end points 12.

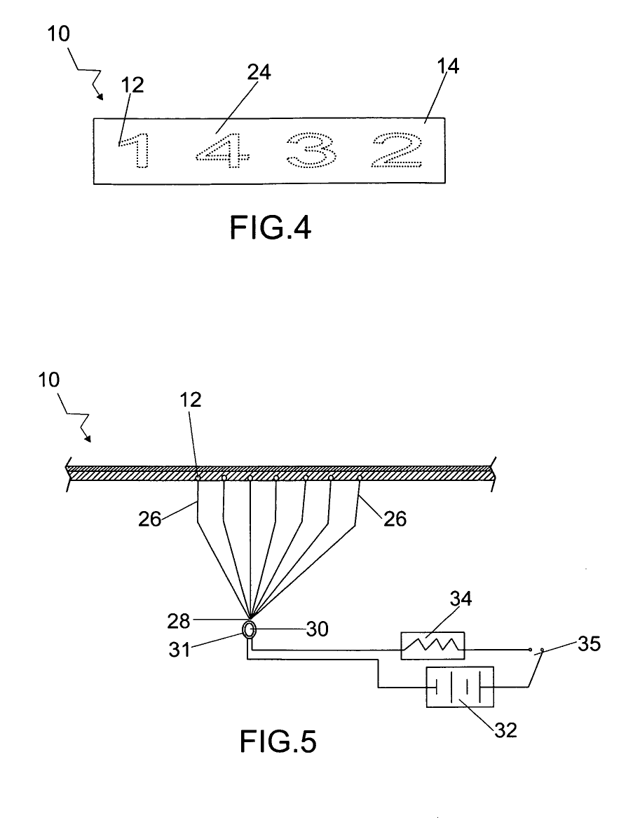

Referring to FIGS. 3 and 4, alternative embodiments of strip 10 are shown that define alternative arrangements of optic end points 12. Strip 10, in these alternative embodiments, accommodates optic fiber end points 12 that define an image of diamonds 22 or alphanumeric characters 24 throughout the first material 14. However, it is understood that fiber optic end points 12 can define other graphic images such as triangles, hearts, stars and other polygonal shapes in other alternative embodiments.

Referring to FIG. 5, each fiber optic end point 12 defines a proximal end of each light pipe 26 that is preferably made of a flexible transparent strand of plastic such as Mitsubishi ESKA plastic optical fiber and is preferably adapted to channel light energy up to fiber optic end points 12. However, the light pipes 26 also can be made of other manufactured optical cables of different characteristics in other alternative embodiments. The light energy in this one embodiment is an infrared light energy that can go beyond the surface of materials for the purpose of location and identification, however, it is understood the light energy can be a visible light energy in the other alternative embodiments.

The light energy carried by light pipes 26 advantageously escapes or spreads from strip 10 towards a viewer with an increased width of light footprint emissions. In one embodiment, the light pipes 26 have their distal ends bundled together to define a tip 28 that is preferably connected to at least one light emitting diode 30 (hereinafter LED 30), however, it is understood that the number of LEDs 30 may vary with the number of light pipes 26 in other alternative embodiments. LED 30 is preferably incorporated or mounted inside epoxy or other optically clear fixative filled tubes 31 to protect LED 30 from being contacted with external moisture. The tubes 31 also act as an air insulator in order to avoid shorting of the diode 30. Each LED 30 is connected to a battery source 32 that is adapted to light LED 30. In one embodiment, the battery source includes 2450 coin cells, however, lightweight “AAAA” style batteries, or other lightweight batteries are contemplated in other alternative embodiments. Each LED 30 is connected to a current limiting resistor 34 that is adapted to lower the current draw of the LEDs 30. The battery source 32 and current limiting resistor 34 are connected to each other through a switch 35. The switch 35 preferably lights up LED 30 in a close position and switch offs LED 30 in an open position. Switch 35 in this embodiment is a manual switch, however, it is understood that switch 35 can be a remote RF switch in other alternative embodiments to operate strip 10 from a remote location. In this one preferred embodiment, a single LED 30 can light up several sets of designs and/or lines of endpoints 12 through light pipes 26 instead of using separate LEDs 30 to light up separate end point 12. The single LED 30, in this one preferred embodiment, can produce 300 points of light output as strip 10 incorporates quiescent technique in battery source 32 to drive the LED 30 which can be substituted for a self-contained blinking LED to produce a flashing effect from the strip. This allows strip 10 to produce continuous light output for at least 2-3 weeks on a tiny set of batteries such as 2450 coin cells or lightweight “AAAA” style batteries.

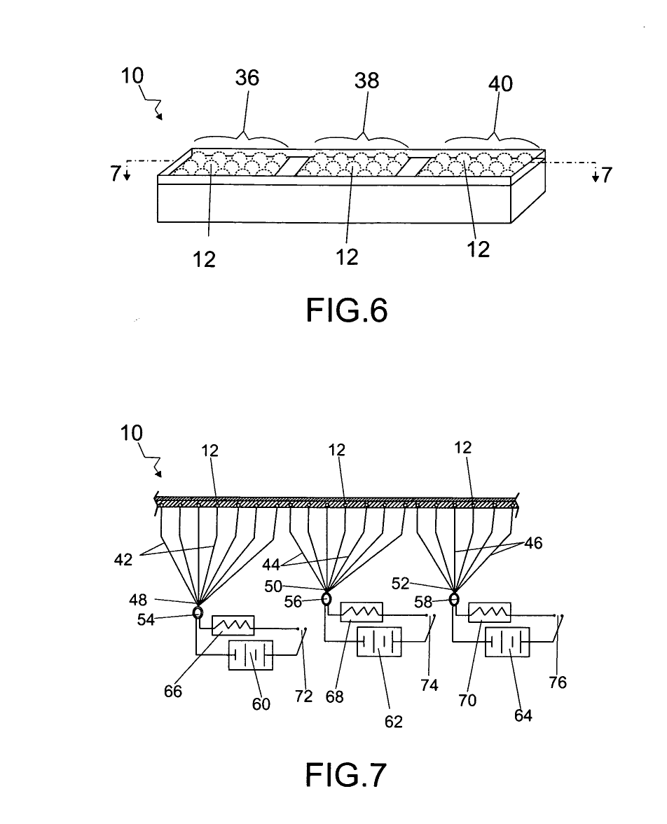

Referring to FIGS. 6 and 7, an alternative embodiment of the reflective strip 10 is shown wherein the optic fiber endpoints 12 are arranged to form three rectangular sections 36, 38 and 40. In this alternative embodiment, end points 12 of each of the sections 36, 38 and 40 are respectively connected to three different light pipe sections 42, 44 and 46. The light pipe sections 42, 46 are adapted to carry and spread visible light energy through end points 12 of sections 36 and 40 towards a viewer. The light pipe section 44 is adapted to carry and spread infrared light energy through end points 12 of section 38 towards the viewer. The strip 10 advantageously allows the user to emit visible light energy and/or infrared light energy by utilizing sections 36, 38 and 40. The light pipe sections 42, 44 and 46 have their distal ends bundled together to define tips 48, 50 and 52 that are preferably connected to LEDs 54, 56 and 58. In this alternative embodiment, LEDs 54 and 58 are visible LEDs and LED 56 is an infra red LED. The LEDS 54, 56 and 58 are respectively connected to battery sources 60, 62 and 64 that are preferably adapted to light LEDs 54, 56 and 58. The LEDs 54, 56 and 58 are connected to current limiting resistors 66, 68 and 70 that are respectively adapted to lower the current draw of the LEDs 54, 56 and 58. The battery sources 60, 62, 64 and resistors 66, 68, 70 are connected to each other via switches 72, 74 and 76. It is understood that switches 72, 74 and 76 can be manual switches or automatic RF switches designed per the requirements of the user. The LEDs 54, 56 and 58, in this one alternative embodiment, are configured to emit different colored light energies, for example, green, yellow and red. This facilitates the strip 10 user to produce different colored visible and/or infrared light energy output at the same time. It is further understood that battery sources 60, 62, and 64 with associated switches 72, 74, and 76 can be located remotely from the strip itself and connect through a jack mechanism.

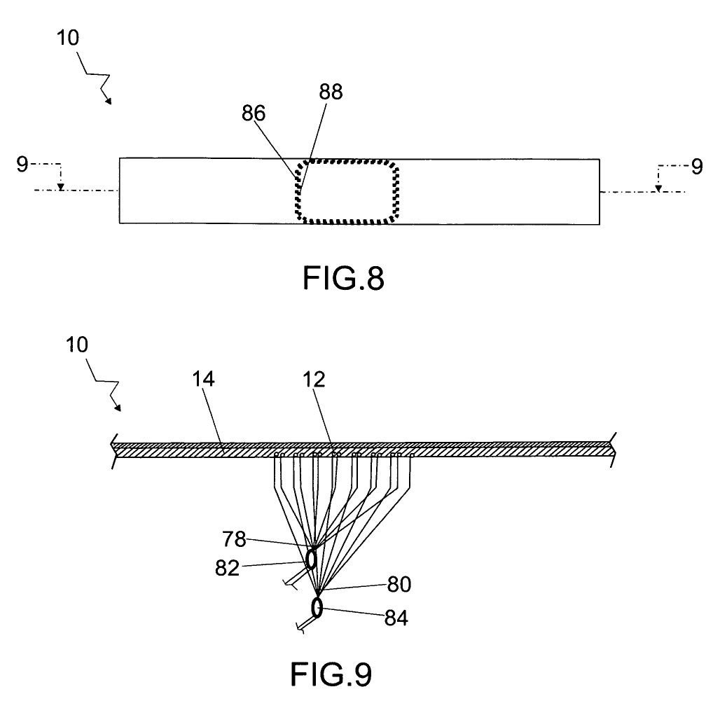

Referring to FIGS. 8 and 9, an alternative embodiment of reflective strip 10 is shown wherein strip 10 can contain several different images, for example, messages, graphics, and directional arrows that are occupied by the same area by being overlapped over one another. In this alternative embodiment, the end points 12 and light pipes 26 preferably define a first bundle 78 and a second bundle 80. Bundles 78 and 80 are adapted to be lighted independently using a first LED 82 and a second LED 84. In this alternative embodiment, the first bundle 78 is preferably positioned between the second bundle 80 such that the end points 12 of first bundle 78 are arranged in an alternate fashion with end points 12 of second bundle 80. This facilitates first and second bundles 78, 80 to preferably occupy the same area of planer surface 14 thereby forming two different rectangular line images 86 and 88 over one another in the same area. In this alternative embodiment, the rectangular line images 86, 88 can be activated separately although they are overlapped over one another. The bundles 78, 80 in this one embodiment respectively emit white and red colored visible and/or infrared light energies, however, it is understood that bundles 78, 80 can emit other colored visible and/or infrared light energies in other alternative embodiments. Thus, the first material 14 of strip 10 has an ability to accommodate or occupy multiple overlapping images or alphanumeric characters within a small area that are individually operable via user-selectable switches. However, it is understood that images 86, 88 can be simultaneously operated to transmit both infrared and visible light energies for purposes of visual identification.

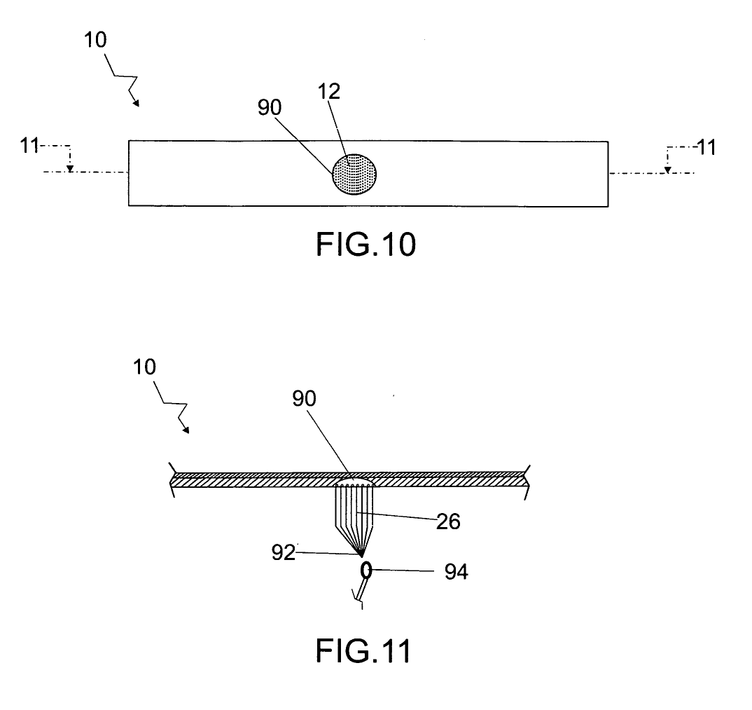

Referring to FIGS. 10 and 11, an alternative flashlight embodiment of strip 10 is shown wherein a plurality of fiber optic points 12 are condensed into a small circular area 90 so that light pipes 26 are gathered together to form a bundle 92 that is connected to a single a visible or an infrared LED 94. The bundle 92 facilitates the strip 10 to have dense array of light pipes 26 within a circular area 90 so that area 90 can emit an intense focus of visible or infrared light energy that is enough to act as a flashlight in darkened areas.

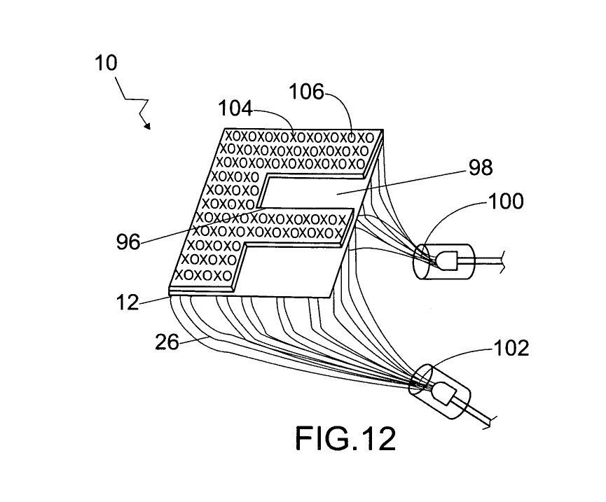

Referring to FIG. 12, an alternate embodiment of strip 10 is shown wherein fiber optic end points 12 and light pipes 26 are attached to an image 96 of fabric 98 so that light pipes 26 are separated into two distinct bundles 100, 102. The bundles 100, 102 together encompass an entire image 96 on the surface of a fabric 98 using alternating fiber implants 104 and 106 that facilitate the option of using two distinctly different light energy sources. The alternative fiber implants 104 and 106 are respectively represented as “X” and “O” in this one alternative embodiment. Bundle 100, in this one embodiment, is connected to a visible diode 108 that emits a visible light energy from image 96 to advantageously allow the viewer to see image 96 with naked eyes in dust-free conditions. Bundle 102, in this one embodiment, is connected to an infrared diode 110 that emits an infrared light energy from image 96 that advantageously allows the viewer to see image 96 with special IR sensitive equipment in dusty and opaque conditions where visible light can not be recognized by the naked eyes. Diodes 108,110, in this one embodiment, are operated individually, however, it is understood that diodes 108, 110 can be operated simultaneously in other alternative embodiments to facilitate image 96 to be recognized by IR sensitive equipment as well as naked eyes.

As shown in FIGS. 1-12, reflective strip 10, in operation, can be advantageously used in the area of safety apparels to assist the wearer. The strip 10 can be advantageously used over various areas of safety apparels, for example, arm bands, leg bands, chest strip and back strip. The strip 10 can have two areas of implants respectively for front and rear areas with different colored LEDs 30. This allows the other persons, such as workers and drivers in mines to immediately determine the physical orientation of the wearer in totally darkened work areas by identifying the color of the LED 30.

The optic fiber end points 12 and light pipes 26, in operation, advantageously channel and transmit the infrared and/or visible light energy from the surfaces 14 embedded in the fabrics and from single source of LED 30, without the need of the use of separate power source for individual fixed point of light pipe 26 as found in the prior arts. This advantageously allows strip 10 to spread out the area of light output by maximizing the IR footprint as it spreads the IR transmission across a larger surface rather than emanating from a single fixed point such as a single LED.

Strip 10, in operation, advantageously uses infrared diodes 30 that emit the infrared light energies that can be recognized using special IR sensitive equipments in adversely hostile visual conditions such as opaque dust clouds, excess condensation in the air, and unavailability of visible light. The special IR sensitive equipments that can be used for infrared identification are standard consumer digital camera, webcam type camcorders, IR vision equipment, and/or video camera containing CCD technology. This feature of the strip is helpful in finding missing or injured persons wearing strip 10 who are unable to move or speak.

Strip 10, in operation, can be advantageously used for verifying the location and identification of an individual in mining situations under unimpeded visual circumstances. Strip 10 can have a visual ID number on the strip 10 that can be recognized by IR sensitive equipment. The visual ID number can be recognized from a long distance by anyone from co-workers who monitors the IR sensitive equipment.

Strip 10, in operation, advantageously has an ability to sequence the light patterns in various frequencies and timings that can be considered as security codes. These security codes can be easily seen by the co-workers and other personnel to immediately get notified about the predefined situation assigned to that security code. The light output embodiment of strip 10 produces flashing patterns using Bluetooth transmissions from detection sensors to light strip 10 to advantageously alert rescuers, safety inspectors, and other personnel in the conditions such as increased amounts of dangerous gases, lack of oxygen, and even physical stress levels of the wearer. The Bluetooth transmissions produced by sensors and transmitted to strip 10 are adapted to be recognized using the Biosensors. The said use of strip 10 is also applicable in high noise areas where trucks, equipment, machines drown out anyone's voice.

The fiber optic end points 12, in operation, are strategically placed throughout the fabric with a visible LED output that advantageously produces 360 degrees of light out put with minimum number of LEDs 30. The single LED 30 can produce 300 points of light output as strip 10 incorporates quiescent technique to drive the LED 30. Hence, the safety apparel can display light for weeks on a tiny set of batteries such as 2032 coin cells or only three “AAAA” batteries.

The dual transmission embodiment of strip 10, in operation, allows the user to selectively activate LEDs 108, 110. This allows the user to produce a “user-selectable” high intensity light output from a small area in the fabric 98 resulting in a beam of light emitted similar to a flashlight. This can be used as an emergency light in case of loss or battery failure. This also facilitates the user to have blinking fiber optic end points 12 that display blinking color chosen to be recognized as a warning. This can help fellow workers to visually get notified immediately about a problem when environments are filled with high volume noise levels from equipment and working procedures. The dual transmission embodiment of strip 10, in operation, also has an ability to simultaneously set both visual and infrared light energy output allowing total recognition of identity by public and individuals with or without CCD receptive equipment. This option may prove useful for law enforcement officers at night when they are out of their vehicles along dark roads to provide identification as well as increasing visibility for passing drivers.

The power source embodiments of strip 10, for example, battery source 32, current limiting resistor 34, batteries, light pipes 26 and LED 30 are advantageously protected by being located inside and away from the surface 14 of strip 10, which provides an inbuilt protection for the power source embodiments and limits the use of unnecessary additional protection mechanisms that wired electronic lighting systems usually require.

Strip 10, in operation, can be advantageously used in suspenders and utility belts designed to hold tools. The strip 10 can have the end points 12 of light pipes 26 pointing outward toward a viewer for the purpose of projecting light assisting peripheral viewing of work areas and to allow fellow workers to easily see them.

Strip 10, in operation, also can be used in safety cone for displaying specific colors in coordination with sensors that detect dangerous gases to allow workers to immediately become aware of what dangers are present. The strips 10 affixed to the circumference of the cone can alert people of cliff edges, dangerous sink holes, wells, and other dangers where light is not being shined on them. Strip 10 also can be advantageously used in the Directional Rope Cone (DRC) that assists miners in the dark areas for directing them towards safety. The directional rope cone can contain impact sensitive switches that light up the fiber optic strips 10 on their surfaces to light up the way to safety.

The strip 10, in operation, can have RF, UHF signals or a motion detection switch with a timed delay circuit to light up diodes 30 remotely only for a short time that advantageously conserves energy and allows the battery source 32 to be used for longer periods without being replaced. The embodiments of the invention shown and discussed herein are merely illustrative of modes of application of the present invention. Reference to details in this discussion is not intended to limit the scope of the claims to these details, or to the figures used to illustrate the invention.

What is claimed is:

1. A fiber optically enhanced reflective strip comprising:
a first material,
a light pipe inside the first material having an end, and
a LED positioned proximate the end of the light pipe to transmit visible or infrared light to the first material to illuminate the material.

2. The reflective strip of claim 1, wherein the first material includes one or more glass beads adapted to facilitate high reflectivity.

3. The reflective strip of claim 2, wherein the light pipe has a ball or bubble like shape.

4. The reflective strip of claim 3, wherein the ball or bubble like shape of the light pipe is adapted to spread 360° of visible and/or infra red light output.

5. The reflective strip of claim 1, wherein the LED is adapted to be mounted within an epoxy filled tube;

6. The reflective strip of claim 1, wherein the strip further comprises a covering layer, the covering layer has a bottom surface adapted to be connected to the first material.

7. The reflective strip of claim 1, wherein the strip has an undersurface that is adapted to include an attachment means that enables the strip to be attached to a fabric or other surfaces.

8. The reflective strip of claim 7, wherein the attachment means of the reflective strip can be made of a magnetic means to facilitate attachment of the reflective strip to the metallic surfaces.

9. The reflective strip of claim 7, wherein the attachment means of the reflective strip can be made of Hook and Loop material to facilitate attachment of the reflective strip to the fabric surface.

10. The reflective strip of claim 1, wherein the strip surface is made of highly reflective 3M High Visibility Reflective 6260 material.

11. The reflective strip of claim 1, wherein the light pipe is made of flexible transparent strands of plastic.

12. The reflective strip of claim 5, wherein the epoxy filled tube protects the LED against external moisture and also acts as an air insulator for preventing shorting of the LED.

13. The reflective strip of claim 1, further comprising a battery source adapted to light the light emitting diode

14. The reflective strip of claim 1, wherein the battery source incorporates a quiescent technique.

15. The reflective strip of claim 13, wherein the strip is adapted to be activated remotely through RF, UHF signals, or locally by way of motion detection switches for a preprogrammed timed period in order to ensure least power consumption and prolong battery life.

16. The reflective strip of claim 6, wherein the covering layer is adapted to protect the LED from being contacted with any exterior surfaces.

17. The reflective strip of claim 1, wherein the strip is adapted to recognize physical stress levels of the wearer of the strip by identifying Bluetooth transmissions from the strip using biosensors with a transmission mechanism to connect to the safety strips.

18. The reflective strip of claim 1, the battery source is adapted to be connected to a current limiting resistor and a switch, the switch adapted to be operated manually or automatically between a close position and an open position to respectively light up and switch off the LED, wherein the battery source is adapted to produce a continuous output for at least two to three weeks.
